(19) United States
(12) Patent Application Publication
(10) Pub. No.: US 2015/0273460 A1
(43) Pub. Date: Oct. 1, 2015

(54) REGENERATION OF AN ACIDIC CATALYST BY ALKYLATION OF AROMATIC COMPOUNDS

(71) Applicant: UOP LLC, Des Plaines, IL (US)

(72) Inventors: Avram M. Buchbinder, Chicago, IL (US); Susie C. Martins, Carol Stream, IL (US); John Q. Chen, Glenview, IL (US)

(73) Assignee: UOP LLC, Des Plaines, IL (US)

(21) Appl. No.: 14/229,290

(22) Filed: Mar. 28, 2014

(51) Int. Cl. B01J 31/40; C10L 1/16; B01J 31/14

(52) U.S. Cl. CPC B01J 31/4092; B01J 31/143; C10L 1/16; C10L 2290/24

(57) ABSTRACT

Methods for regenerating deactivated acidic catalyst containing conjunct polymer are described. The deactivated acidic catalyst containing conjunct polymer is contacted with at least one aromatic compound in a regeneration zone under regeneration conditions. The conjunct polymer reacts with the at least one aromatic compound resulting in a regenerated acidic catalyst and at least one aromatic compound alkylated with conjunct polymer. The acidic catalyst is selected from the group consisting of sulfuric acid, hydrofluoric acid, trifluoromethanesulfonic acid, phosphoric acid, boron trifluoride, toluenesulfonic acid, trifluoroacetic acid, and acidic ionic liquids.

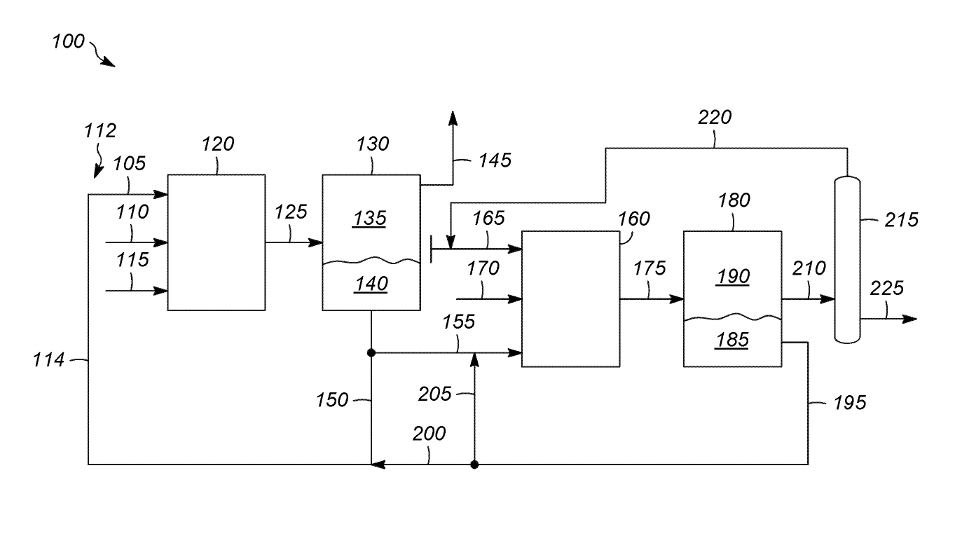

### BACKGROUND OF THE INVENTION

Commercially, the alkylation of isoparaffins is catalyzed by acids such as sulfuric acid and hydrofluoric acid. Conjunct polymer (acid soluble oils, (ASO) also known as red oil) forms as a byproduct of the alkylation reaction, as well as other hydrocarbon reactions. When too much conjunct polymer is present, the acid catalyst loses its effectiveness. The acid must be replaced with stronger acid, or the conjunct polymer must be removed in order to reactivate the catalyst. With sulfuric acid as the catalyst, the ASO is burned, and with hydrofluoric acid, the hydrofluoric acid is distilled away from the ASO. Sulfuric acid and hydrofluoric acid are hazardous and corrosive, and their use in industrial processes requires a variety of environmental controls.

There has been a move to replace the use of sulfuric acid and hydrofluoric acid with more environmentally friendly materials.

A group of such processes utilizes acidic ionic liquids as catalysts in hydrocarbon conversion processes, such as alkylation, isomerization, disproportionation, and oligomerization. Conjunct polymers are byproducts of the hydrocarbon reaction using ionic liquids, and they form a complex with the ionic liquid catalyst. The ionic liquid catalyst loses its effectiveness over time as the amount of conjunct polymer increases. It must then either be replaced or regenerated. Because ionic liquids are typically fairly expensive, processes for regenerating the ionic liquid catalysts are needed.

A variety of methods for regenerating ionic liquids have been developed. The ionic liquid containing the conjunct polymer could be contacted with a reducing metal (e.g., Al), an inert hydrocarbon (e.g., hexane), and hydrogen and heated to about 100° C. The conjunct polymer will be transferred to the hydrocarbon phase, allowing for the conjunct polymer to be removed from the ionic liquid phase. See e.g., U.S. Pat. No. 7,651,970; U.S. Pat. No. 7,825,055; U.S. Pat. No. 7,956,002; and U.S. Pat. No. 7,732,363.

Another method involves contacting the ionic liquid containing the conjunct polymer with a reducing metal (e.g., Al) in the presence of an inert hydrocarbon (e.g. hexane), but in the absence of added hydrogen, and heating to about 100° C. The conjunct polymer will be transferred to the hydrocarbon phase, allowing for the conjunct polymer to be removed from the ionic liquid phase. See e.g., U.S. Pat. No. 7,674,739.

Still another method of regenerating the ionic liquid involves contacting the ionic liquid containing the conjunct polymer with a reducing metal (e.g., Al), HCl, and an inert hydrocarbon (e.g. hexane), and heating to about 100° C. The conjunct polymer will be transferred to the hydrocarbon phase, allowing for the CP to be removed from the IL phase. See e.g., U.S. Pat. No. 7,727,925.

The ionic liquid can be regenerated by adding a homogeneous metal hydrogenation catalyst (e.g., (PPh₃)₃RhCl) to the ionic liquid containing the conjunct polymer and an inert hydrocarbon (e.g. hexane). Hydrogen would be introduced, and the conjunct polymer would be reduced and transferred to the hydrocarbon layer. See e.g., U.S. Pat. No. 7,678,727.

Another method for regenerating the ionic liquid involves adding HCl, isobutane, and an inert hydrocarbon to the ionic liquid containing the conjunct polymer and heating to about 100° C. The conjunct polymer would react to form an uncharged complex, which would transfer to the hydrocarbon phase. See e.g., U.S. Pat. No. 7,674,740.

The ionic liquid could also be regenerated by adding a supported metal hydrogenation catalyst (e.g. Pd/C) to the ionic liquid containing the conjunct polymer and an inert hydrocarbon (e.g. hexane). Hydrogen would be introduced and the conjunct polymer would be reduced and transferred to the hydrocarbon layer. See e.g., U.S. Pat. No. 7,691,771.

Still another method involves adding a basic reagent that displaces the conjunct polymer and is a part of the regeneration of the catalyst. The basic reagents are described as nitrogen-containing compounds such as amines, pyridinium compounds, or pyrrolidinium compounds. For example, a suitable substrate (e.g. pyridine) is added to the ionic liquid containing the conjunct polymer. After a period of time, an inert hydrocarbon would be added to wash away the liberated conjunct polymer. The ionic liquid precursor [1-butyl-pyridinium][Cl] would be added to the ionic liquid (e.g. [1-butyl-pyridinium][Al₂Cl₇]) containing the conjunct polymer followed by an inert hydrocarbon. After a given time of mixing, the hydrocarbon layer would be separated, resulting in a regenerated ionic liquid. The solid residue would be converted to catalytically active ionic liquid by adding AlCl₃. See e.g., U.S. Pat. No. 7,737,363 and U.S. Pat. No. 7,737,067.

Another method involves adding the ionic liquid containing the conjunct polymer to a suitable substrate (e.g. pyridine) and an electrochemical cell containing two aluminum electrodes and an inert hydrocarbon. A voltage would be applied and the current measured to determine the extent of reduction. After a given time, the inert hydrocarbon would be separated, resulting in a regenerated ionic liquid. See, e.g., U.S. Pat. No. 8,524,623.

All of these regeneration approaches have drawbacks. Hydrogenation of the spent ionic liquid with supported (e.g., U.S. Pat. No. 7,691,771) and unsupported (e.g., U.S. Pat. No. 7,678,727) hydroprocessing catalysts may result in the active catalytic metals being extracted into the ionic liquid phase. Many catalyst supports also react irreversibly with the chloroaluminate anion of the ionic liquid. Although the use of metallic aluminum for regeneration (e.g., U.S. Pat. No. 7,995,495) is effective, it introduces undesirable solids handling issues into the refinery. Finely divided aluminum is pyrophoric and presents safety issues in a refining environment. This approach also results in the creation of additional AlCl₃, which has to be removed from the ionic liquid phase (e.g., U.S. Pat. No. 7,754,636) to avoid building up to a molar ratio relative to the ionic liquid cation at which solids will start coming out of solution and cause plugging issues. Electrochemical approaches (e.g., U.S. Pat. No. 8,524,623) are not economically viable at commercial scales.

Therefore, there remains a need for additional methods of regenerating ionic liquids used as catalysts in reactions.

### SUMMARY OF THE INVENTION

One aspect of the invention is a method for regenerating deactivated acidic catalyst containing conjunct polymer. In one embodiment, the deactivated acidic catalyst containing conjunct polymer is contacted with at least one aromatic compound in a regeneration zone under regeneration conditions. The conjunct polymer reacts with the at least one aromatic compound resulting in at least one aromatic compound alkylated with conjunct polymer. The acidic catalyst is selected from the group consisting of sulfuric acid, hydrofluoric acid, trifluoromethanesulfonic acid, phosphoric acid, boron trifluoride, toluenesulfonic acid, trifluoroacetic acid, and acidic ionic liquids.

### BRIEF DESCRIPTION OF THE DRAWING

The FIGURE illustrates one embodiment of a process according to the present invention.

### DETAILED DESCRIPTION OF THE INVENTION

It has been discovered that deactivated acidic catalysts containing conjunct polymer can be regenerated using a reagent that contains no metals and that reacts at mild conditions. In some embodiments, the reagent can be easily separated by gravity from the ionic liquid and/or extraction. When a liquid reagent is used, the process does not produce any net solids that have to be handled or treated. When solvents are used with liquid reagent, the liquid reagent can be easily separated from the solvent.

By deactivated acidic catalysts containing conjunct polymer, we mean acidic catalysts that have been used in hydrocarbon conversion processes, and in which conjunct polymers have formed. Deactivated acidic catalysts include partially or completely deactivated acidic catalysts. Acidic catalysts which promote formation of conjunct polymers in hydrocarbon conversion processes include sulfuric acid, hydrofluoric acid, trifluoromethanesulfonic acid (triflic acid), phosphoric acid, boron trifluoride, toluenesulfonic acid, trifluoroacetic acid, and acidic ionic liquids such as those containing chloroaluminate anions. By conjunct polymer, we mean the olefinic, conjugated, cyclic hydrocarbons that form as a byproduct of various hydrocarbon conversion processes, including but not limited to alkylation, oligomerization, isomerization, and disproportionation. By acidic ionic liquid, we mean an ionic liquid capable of catalyzing reactions typically carried out with an acid. As known in the art, acids such as sulfuric acid and hydrofluoric acid are often used to catalyze these reactions. These reactions include, e.g. alkylation, oligomerization, isomerization, and disproportionation. Oftentimes the acids employed in these reactions have Hammett acidity functions (H₀) less than 7, or less than 5, or less than 3, or less than 0, or less than −3, or less than −5, or less than −7, or less than −9. If the ionic liquid does not possess an acidic proton in its structure (e.g. 1-butyl-3-methylimidazolium heptachloroaluminate), addition of an exogenous acid is acceptable, provided the Hammett acidity function (H₀) of the added acid is less than 7 within the ionic liquid, or less than 5, or less than 3, or less than 0, or less than −3, or less than −5, or less than −7, or less than −9. Acidic chloroaluminate-containing ionic liquids have a cation to anion ratio greater than 1.

The contact of an aromatic compound with an acidic catalyst that contains conjunct polymer results in the alkylation of the aromatic compound with the conjunct polymer. The acidic catalyst can be separated from the aromatic compound alkylated with the conjunct polymer.

When the acidic catalyst is an ionic liquid, the ionic liquid can then be reactivated with acid or an acid precursor. Other acidic catalysts may also require reactivation. The reactivated acid catalyst can be separated from the aromatic compound alkylated with the conjunct polymer, and the reactivated acidic catalyst can be recycled.

The aromatic compound reacts with the unsaturated sites of the conjunct polymer. The reaction displaces the conjunct polymer from the acid catalyst. The alkylated aromatic can then be separated from acid catalyst. The reaction can be catalyzed by the remaining acidity of the deactivated acidic catalyst, or an additional acid can be used.

The deactivated acidic catalyst and the aromatic compound are contacted for a period of time sufficient to allow the conjunct polymer to react with the aromatic compound. This will typically take in the range of about 5 min to about 10 hr, or about 10 min to about 6 hr, or about 30 min to about 4 hrs.

The contacting typically takes place at a temperature in the range of from about −20° C. to the degradation temperature of the acidic catalyst. For ionic liquids, the upper limit is the decomposition temperature of the ionic liquid. A typical temperature range is about 20° C. to about 200° C., or about 50° C. to about 120° C., or about 60° C. to about 90° C.

The pressure is typically ambient pressure, although higher or lower pressures could be used if desired. The pressure is generally in the range of about 0 MPa(g) (0 psig) to about 3.4 MPa(g) (500 psig), or about 0 MPa(g) (0 psig) to about 2.1 MPa(g) (300 psig). Higher pressure may be desirable if the process is integrated with an alkylation process which must be run above the bubble point of isobutane (e.g., about 345 kPa(g) (50 psig) to about 483 kPa(g) (70 psig). Higher pressure is needed if C₃ olefins are used.

In some embodiments, the contacting takes place in the presence of a solvent. Solvent is not always necessary, but it will maximize recovery, removal, and separation of the conjunct polymer.

The reaction can take place in the presence of a Lewis acid and a Brønsted acid. In some embodiments, the Lewis acid and the Brønsted acid are present in the acid catalyst. For example, when an ionic liquid is used, the ionic liquid itself may serve as the Lewis acid and the Brønsted acid. The Brønsted acid may be present because it was added in the form of HCl or chlorobutane or other chloro-alkane, or because it is generated as a result of residual water in the ionic liquid precursor. In other embodiments, the Lewis acid and/or the Brønsted acid will need to be added separately. Despite being partially deactivated, the deactivated ionic liquid catalyst may serve as the catalyst for the regeneration as the required acid strength for alkylating an aromatic is less than for alkylating an isoparaffin.

In some embodiments, there are about 0.03 to about 0.3 moles of aromatic compound added per gram of conjunct polymer, or about 0.05 to about 0.2.

The contacting can take place in any suitable process, such as solvent extraction, or contacting in one or more mixer/settlers.

The reaction will proceed simply by contacting the aromatic compound with the liquid acidic catalyst. However, the mixture can be stirred or otherwise sheared to increase the contact between the aromatic compound and the acidic catalyst. Stirring is particularly useful when the acidic catalyst is an ionic liquid.

The contacting step may be practiced in laboratory scale experiments through full scale commercial operations. The process may be operated in batch, continuous, or semi-continuous mode. The contacting step can take place in various ways, with both countercurrent and co-current flow processes being suitable. The order of addition of the reactants is not critical. For example, the reactants can be added individually, or some reactants may be combined or mixed before being combined or mixed with other reactants.

In some embodiments, after the deactivated acidic catalyst and the aromatic compound have been contacted, two phases result, a catalyst phase containing the acidic catalyst and a hydrocarbon phase containing the aromatic compound alkylated with the conjunct polymer and solvent, if present. In some embodiments, the phases will separate due to the density difference between the two phases, which can then be recovered by decanting the top layer, draining the bottom layer, continuously flowing the top layer out of the regeneration zone or continuously flowing the bottom layer out of the regeneration zone. In other embodiments, other separation processes may be needed, such as extraction of conjunct polymer alkylated with aromatic and any unreacted aromatic. Extraction can be accomplished using, for instance, a paraffin solvent. The extraction will generate a hydrocarbon phase containing the extraction solvent and the majority of conjunct polymer alkylated with aromatic, and a heavy phase containing catalyst. Decanting can be suitable if there is enough aromatic compound alkylated with the conjunct polymer present and it separates from the acidic catalyst.

When the acidic catalyst is an ionic liquid, the ionic liquid can be regenerated by adding an appropriate acid in addition to reaction and extraction of conjunct polymer. The regenerated acidic catalyst can then be recycled to the hydrocarbon conversion process. Other acidic catalyst may also need to be regenerated by adding an appropriate acid. The regeneration of the acidic catalyst can take place during the contacting step or after separation of the catalyst phase and the hydrocarbon phase.

The hydrocarbon phase containing the aromatic compound alkylated with the conjunct polymer can be treated as well. The aromatic compound alkylated with the conjunct polymer can be separated from the solvent and any excess aromatic compound, which can be recycled to the regeneration zone. The separation can take place in a fractionation column, for example.

In one embodiment, the regeneration process is a solvent extraction process. For ease of discussion, the use of deactivated acidic ionic liquid in the solvent extraction process will be described. However, as will be understood by those of skill in the art, other acidic catalysts which form conjunct polymers could also be used.

In the solvent extraction method, a solvent and an aromatic compound are added to the ionic liquid containing conjunct polymer. The solvent and the aromatic compound can be pre-mixed and added together, or they can be added separately, either at the same time or sequentially. In some embodiments, the addition of a Lewis acid catalyst and/or a Brønsted acid may be needed to catalyze the reaction.

The aromatic compound reacts with the unsaturated sites in the conjunct polymer to form an alkylated aromatic compound. The conjunct polymer is thereby removed from the ionic liquid phase to the hydrocarbon phase and can be extracted.

In some embodiments, in a system without stirring or after stirring is ended, the components can separate into two phases based on the density difference between the ionic liquid phase and the hydrocarbon phase which contains the aromatic compound alkylated with the conjunct polymer. Alternatively, the process may be a continuous process in which a first contacting zone is mixed by stirring or other method. The mixture is passed to a settling zone with no stirring or turbulent mixing. In the settling zone, the components can separate into two phases based on the density difference between the ionic liquid phase and the hydrocarbon phase which contains the aromatic compound alkylated with the conjunct polymer. The ionic liquid will settle to the bottom, and the aromatic compound alkylated with the conjunct polymer will be on top of the ionic liquid layer. Increasing the top layer with additional solvent will increase conjunct polymer recovery. Preferably the additional solvent is added with mixing, either during the mixing step or in the contacting zone or in an extraction zone. In the last case, the mixture from the contacting zone may be fed to an extraction zone and mixed with additional solvent to maximize extraction and then fed to the settling zone.

The deactivated ionic liquid, the solvent, and the aromatic compound are contacted long enough for the conjunct polymer to react with the aromatic compound, typically about 10 min to about 6 hr. The deactivated ionic liquid, the solvent, and the aromatic compound are typically mixed while being contacted.

The deactivated ionic liquid, the solvent, and the aromatic compound are typically contacted at a temperature in the range of from about −20° C. to less than the decomposition temperature of the ionic liquid, or about 20° C. to about 200° C., or about 50° C. to about 100° C., or about 70° C. to about 90° C.

The mixture is then allowed to separate into two phases: an ionic liquid phase and a hydrocarbon phase. In some embodiments, separation occurs due to the density difference between the ionic liquid phase and the hydrocarbon phase. Separation typically takes on the order of a few minutes to hours; it is generally less than about 1 hr. In some embodiments, the separation can be a continuous process.

The solvent layer is removed from the ionic liquid. The ionic liquid can be further washed with solvent (either the same solvent used in the extraction or a different one), if desired. As the reaction occurs, the conjunct polymer is extracted into the solvent layer.

In some embodiments, the addition of an acid or an acid precursor regenerates the ionic liquid following removal of the conjunct polymer or during the contacting step.

Suitable acids and acid precursors include, but are not limited to, HCl, tert-butyl chloride, or 2-chlorobutane. The acid precursor can be any molecule that will break down to form the acid. Reactivation of the ionic liquid with acid or acid precursor typically takes about 5 sec to about 30 min. It can be done at a range of temperatures. For convenience, it is typically done at the same conditions as the hydrocarbon conversion process which generates the conjunct polymer.

The ionic liquid can be any acidic ionic liquid. There can be one or more ionic liquids. The ionic liquid comprises an organic cation and an anion. Suitable cations include, but are not limited to, nitrogen-containing cations and phosphorus-containing cations. Suitable organic cations include, but are not limited to:

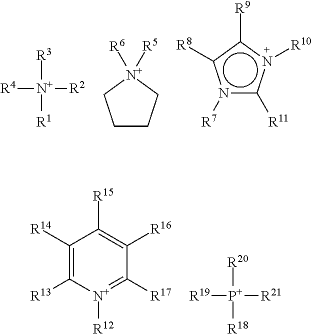

where R¹-R²¹ are independently selected from C₁-C₂₀ hydrocarbons, C₁-C₂₀ hydrocarbon derivatives, halogens, and H. Suitable hydrocarbons and hydrocarbon derivatives include saturated and unsaturated hydrocarbons, halogen substituted and partially substituted hydrocarbons and mixtures thereof. C₁-C₈ hydrocarbons are particularly suitable.

The anion can be derived from halides, typically halometallates, and combinations thereof. The anion is typically derived from metal and nonmetal halides, such as metal and nonmetal chlorides, bromides, iodides, fluorides, or combinations thereof. Combinations of halides include, but are not limited to, mixtures of two or more metal or nonmetal halides (e.g., AlCl₄⁻ and BF₄⁻), and mixtures of two or more halides with a single metal or nonmetal (e.g., AlCl₃Br). In some embodiments, the metal is aluminum, with the mole fraction of aluminum ranging from 0<Al<0.25 in the anion. Suitable anions include, but are not limited to, AlCl₄⁻, Al₂Cl₇⁻, Al₃Cl₁₀⁻, AlCl₃Br⁻, Al₂Cl₆Br⁻, Al₃Cl₉Br⁻, AlBr₄⁻, Al₂Br₇⁻, Al₃Br₁₀⁻, GaCl₄⁻, Ga₂Cl₇⁻, Ga₃Cl₁₀⁻, GaCl₃Br⁻, Ga₂Cl₆Br⁻, Ga₃Cl₉Br⁻, CuCl₂⁻, Cu₂Cl₃⁻, Cu₃Cl₄⁻, ZnCl₃⁻, FeCl₃⁻, FeCl₄⁻, Fe₃Cl₇⁻, PF₆⁻, and BF₄⁻.

The aromatic compound can be any aromatic compound which can be alkylated. In some embodiments, the aromatic compound is an aromatic compound having the formula:

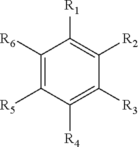

where each R is independently selected from hydrogen, C₁-C₁₂ hydrocarbons or hydrocarbons substituted with halides, with at least one R being hydrogen. In some embodiments the aromatic compound may also have two or more benzene rings, such as naphthalene or a naphthalene derivative of the formula:

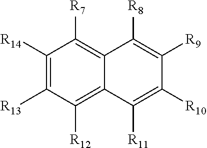

where each R is independently selected from hydrogen, C₁-C₁₂ hydrocarbons, or C₁-C₁₂ hydrocarbons substituted with halides, with at least one R being hydrogen.
There can be one or more aromatic compounds. Examples of suitable aromatic compounds include benzene, toluene, xylenes, trimethylbenzenes, tetramethylbenzenes, naphthalene, alkylnapthalenes, ethylbenzene, methyl-ethyl benzenes, diethyl benzenes, methyl diethyl benzenes, propylbenzenes, butyl benzenes, or combinations thereof.

The solvent used in the contacting step will depend on the acidic catalyst being regenerated. The solvent can be any solvent which is capable of forming a separate phase from the catalyst phase. There can be one or more solvents. Suitable solvents for halometallate ionic liquids include, but are not limited to, C₄ to C₁₆ paraffins including n-paraffins, isoparaffins, and cyclic paraffins, and aromatic solvents. If the ionic liquid is soluble in hydrocarbons, more polar solvents which are not miscible in the ionic liquid would be used. The use of organic solvents may be less desirable with oxidizing acids.

The solvent used in extraction can be the same solvent used in the contacting step or a different solvent.

The reaction can take place in the presence of a Lewis acid and a Brønsted acid. Suitable Lewis acids include, but are not limited to, an ionic liquid containing a metal halide anion, and metal halides, such as AlCl₃, AlBr₃, FeCl₃, FeBr₃, ZnCl₂, BF₃, and the like. Suitable Brønsted acids include, but are not limited to, HCl, HBr, HF, HI, H₂SO₄, H₃PO₄, HNO₃, and the like, and precursors of these acids, such as 2-butyl chloride, or tert-butyl chloride.

The FIGURE illustrates one embodiment of the process 100. For ease of discussion, the process will be described using ionic liquid catalyst. Other acidic catalysts could also be used, as would be understood by those skilled in the art.

The ionic liquid catalyst 105, an acid or acid precursor 110, and a hydrocarbon feed 115 are introduced into a reaction zone 120. The hydrocarbon feed reacts forming reaction products. The ionic liquid catalyst 105 can be a mixture of fresh ionic liquid 112 and recycled ionic liquid 114.

The effluent 125 from the reaction zone 120 contains the reaction products, the ionic liquid catalyst, conjunct polymer, and any left over acid or acid precursor, and hydrocarbon feed. The effluent 125 is sent to a separation zone 130 where it is separated into a hydrocarbon phase 135 containing the reaction products, unreacted hydrocarbon feed, a small portion of the acid, and a catalyst phase 140 containing the ionic liquid catalyst, a large portion of the acid, and the conjunct polymer formed in the reaction.

The hydrocarbon stream 145 can be recovered and/or sent for further processing, such as treating to remove acid, and fractionation.

A portion 150 of the catalyst phase 140 is recycled back to the reaction zone 120, and/or a portion 155 of the catalyst phase 140 is sent to a regeneration zone 160. The amounts of the portions 150, 155 can be varied from 0 to 100%. The amounts can be altered based on the amount of conjunct polymer in the catalyst phase. When the level of conjunct polymer increases to an unacceptable level, the portion 155 of the catalyst phase 140 sent to the regeneration zone 160 can be increased.

An aromatic compound 165 and an acid or acids 170 (if needed) are introduced into the regeneration zone 160 along with the portion 155 of the catalyst phase 140. The aromatic compound 165 reacts with the conjunct polymer to form an aromatic compound alkylated with the conjunct polymer.

The effluent 175 from the regeneration zone 160, which includes the ionic liquid catalyst and the aromatic compound alkylated with the conjunct polymer, is sent to a separation zone 180. The effluent 175 is separated into a regenerated catalyst phase 185 containing the regenerated ionic liquid and a hydrocarbon phase 190 containing the aromatic compound alkylated with the conjunct polymer.

A stream 195 of the regenerated catalyst phase 185 can be removed from the separation zone 180. In some embodiments, at least a portion 200 of stream 195 can be recycled back to the reaction zone 120. In some embodiments, at least a portion 205 is recycled back to the regeneration zone 160.

Recycle ionic liquid 114 can include the portion 150 of the catalyst phase 140 and/or the portion 200 of the stream 195 of the regenerated catalyst phase 185.

A stream 210 of the hydrocarbon phase 190 is sent to a separation zone 215 where the solvent and any unreacted aromatic compound 220 are separated from the aromatic compound alkylated with the conjunct polymer 225. The solvent and any unreacted aromatic compound 220 can be recycled to the regeneration zone 160. The aromatic compound alkylated with the conjunct polymer 225 can be recovered.

In some embodiments, the first separation can take place in the reaction zone, and the second separation can take place in the regeneration zone. Separate zones are not required. For example, where the separation takes place due to differences in density, the same zone can be used for reaction and separation and/or for regeneration and separation. In other embodiments, there are separate zones for reaction and separation and/or for regeneration and separation.

### Examples

Several experiments were conducted to examine regenerating an acidic ionic liquid catalyst using an aromatic compound. The spent ionic liquid was tributylhexylphosphonium heptachloroaluminate (TBHP-Al₂Cl₇) that was spent in a continuous reactor for alkylation of isobutane with mixed 2-butenes.

In three experiments done at atmospheric pressure, the reaction of toluene with conjunct polymer was conducted at 80° C. in stirred vials. TBHP-Al₂Cl₇ ionic liquid with 3.1% conjunct polymer was used. No additional solvent was used in order to maximize the toluene concentration. Three different acid conditions were tested: A) addition of 2-chlorobutane; B) addition of fresh TBHP-Al₂Cl₇ ionic liquid; and C) addition of fresh TBHP-Al₂Cl₇ ionic liquid and 2-chlorobutane. After reaction for 3.5 hours, the samples were cooled and extracted in hexane. After hydrolysis of the TBHP-Al₂Cl₇ ionic liquid, extraction of the hydrolyzed TBHP-Al₂Cl₇ ionic liquid in octane, and isolation of the conjunct polymer, the amount of conjunct polymer removal was calculated from the weight of the isolated oil accounting for the amount of toluene in the initial octane extract and the final oil (measured by gas chromatography (GC)). The results are shown in Table 1. It appears that under these conditions, additional Lewis acid in the form of fresh TBHP-Al₂Cl₇ ionic liquid was necessary.

TABLE 1

| | | Mass (g) | | | | |
|---|---|---|---|---|---|---|
| Sample | | | Spent | 2- | fresh | CP |
| number | Aromatic | Aromatic | IL | chlorobutane | IL | removal |
| 1A | Toluene | 3.772 | 6.996 | 0.305 | 0 | <0% |
| 1B | Toluene | 3.758 | 3.797 | 0 | 3.213 | 9% |
| 1C | Toluene | 3.791 | 7.003 | 0.162 | 0.984 | 22% |

Additional experiments were completed similar to 1A, but using m-xylene or mesitylene (1,3,5-trimethylbenzene) as the feed. While mesitylene showed no activity in reaction with conjunct polymer, m-xylene was reactive without the addition of fresh TBHP-Al₂Cl₇ ionic liquid, indicating that it is significantly more active than toluene. The results are shown in Table 2.

TABLE 2

| | | Mass (g) | | | | |
|---|---|---|---|---|---|---|
| Sample | | | Spent | 2- | fresh | CP |
| number | Aromatic | Aromatic | IL | chlorobutane | IL | removal |
| 2A | Toluene | 3.772 | 6.996 | 0.305 | 0 | <0% |
| 2B | mesitylene | 4.825 | 7.029 | 0.306 | 0 | <0% |
| 2 C | m-xylene | 4.559 | 6.996 | 0.301 | 0 | 40% |

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A method for regenerating deactivated acidic catalyst containing conjunct polymer comprising:
contacting the deactivated acidic catalyst containing conjunct polymer with at least one aromatic compound in a regeneration zone under regeneration conditions, the acidic catalyst selected from the group consisting of sulfuric acid, hydrofluoric acid, trifluoromethanesulfonic acid, phosphoric acid, boron trifluoride, toluenesulfonic acid, trifluoroacetic acid, and acidic ionic liquids, the conjunct polymer reacting with the at least one aromatic compound resulting in a regenerated acidic catalyst and at least one aromatic compound alkylated with conjunct polymer.

2. The method of claim 1 wherein the at least one aromatic compound comprises an aromatic compound having a formula 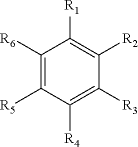
where each R is independently selected from hydrogen, C₁-C₁₂ hydrocarbons or hydrocarbons substituted with halides, with at least one R being hydrogen; or 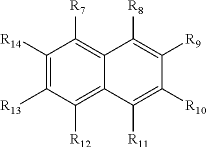
where each R is independently selected from hydrogen, C₁-C₁₂ hydrocarbons, or C₁-C₁₂ hydrocarbons substituted with halides, with at least one R being hydrogen.

3. The method of claim 1 further comprising reactivating the acidic catalyst with an acid or an acid precursor.

4. The method of claim 1 wherein the acidic catalyst comprises the ionic liquid.

5. The method of claim 1 wherein the regeneration conditions include at least one of a temperature in a range of from about −20° C. to less than a degradation temperature of the acidic catalyst, and a contact time in a range of about 10 min and 6 hr.

6. The method of claim 1 wherein contacting the deactivated acidic catalyst containing the conjunct polymer with the at least one aromatic compound takes place in the presence of a solvent.

7. The method of claim 6 wherein the solvent comprises a paraffin having up to 16 carbon atoms.

8. The method of claim 6, further comprising:
separating the solvent from the at least one aromatic compound alkylated with the conjunct polymer; and
recycling the solvent.

9. The method of claim 1 wherein contacting the deactivated acidic catalyst containing the conjunct polymer with the at least one aromatic compound further comprises adding at least one of a Lewis acid and a Brønsted acid.

10. The method of claim 9 wherein the Lewis acid comprises a metal halide or an ionic liquid containing a metal halide anion; or the Brønsted acid comprises HCl, HBr, HF, HI, H₂SO₄, H₃PO₄, HNO₃, or precursors thereof; or both.

11. The method of claim 1 wherein contacting the deactivated acidic catalyst containing the conjunct polymer with the at least one aromatic compound results in a catalyst phase and a hydrocarbon phase containing the at least one aromatic compound alkylated with conjunct polymer.

12. The method of claim 1 further comprising separating the at least one aromatic compound alkylated with conjunct polymer from the regenerated acidic catalyst.

13. The method of claim 12 wherein separating the at least one aromatic compound alkylated with conjunct polymer from the regenerated acidic catalyst comprises extracting the at least one aromatic compound alkylated with conjunct polymer with a solvent.

14. The method of claim 13 wherein the solvent comprises a paraffin having up to 16 carbon atoms.

15. The method of claim 13, further comprising:
separating the solvent from the at least one aromatic compound alkylated with the conjunct polymer; and
recycling the solvent.

16. The method of claim 1 further comprising recycling at least a portion of the regenerated acidic catalyst to the regeneration zone.

17. The method of claim 1 further comprising at least one of:
mixing the at least one aromatic compound alkylated with the conjunct polymer into a fuel;
mixing the at least one aromatic compound alkylated with the conjunct polymer with a feed, and sending the mixture to a hydrocarbon conversion process which forms a fuel; or
processing the at least one aromatic compound alkylated with the conjunct polymer into a surfactant.

18. The method of claim 1 wherein contacting the deactivated acidic catalyst containing the conjunct polymer with the at least one aromatic compound further comprises mixing the deactivated acidic catalyst containing the conjunct polymer and the at least one aromatic compound.

19. The method of claim 1 wherein the at least one aromatic compound is selected from benzene, toluene, xylenes, trimethylbenzenes, tetramethylbenzenes, naphthalene, alkylnapthalenes, ethylbenzene, methyl-ethyl benzenes, diethyl benzenes, methyl diethyl benzenes, propylbenzenes, butyl benzenes, or combinations thereof.

20. A method for regenerating deactivated acidic catalyst containing conjunct polymer comprising:
contacting the deactivated acidic catalyst containing conjunct polymer with at least one aromatic compound in the presence of a solvent, a Lewis acid, and a Brønsted acid in a regeneration zone under regeneration conditions, the acidic catalyst selected from the group consisting of sulfuric acid, hydrofluoric acid, trifluoromethanesulfonic acid, phosphoric acid, boron trifluoride, toluenesulfonic acid, trifluoroacetic acid, and acidic ionic liquids, the conjunct polymer reacting with the at least one aromatic compound resulting in a catalyst phase and a hydrocarbon phase containing at least one aromatic compound alkylated with conjunct polymer;
separating the catalyst phase from the hydrocarbon phase;
separating the hydrocarbon phase into a solvent stream and a stream comprising the at least one aromatic compound alkylated with the conjunct polymer; and
recycling the solvent; wherein the at least one aromatic compound comprises an aromatic compound having a formula 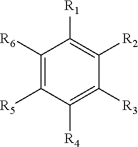
where each R is independently selected from hydrogen, C₁-C₁₂ hydrocarbons, or C₁-C₁₂ hydrocarbons substituted with halides, with at least one R being hydrogen; or 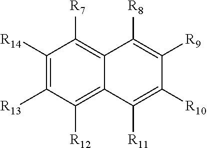
where each R is independently selected from hydrogen, C₁-C₁₂ hydrocarbons, or C₁-C₁₂ hydrocarbons substituted with halides, with at least one R being hydrogen.
